(19) United States
(12) Patent Application Publication
(10) Pub. No.: US 2025/0361751 A1
(43) Pub. Date: Nov. 27, 2025

(54) MOTOR VEHICLE LOCK HAVING AN ELECTRONIC CONTROL DEVICE

(71) Applicants: Kiekert Aktiengesellschaft, Heiligenhaus (DE); AUDI AG, Ingolstadt (DE)

(72) Inventors: Michael SCHOLZ, Essen (DE); Holger SCHIFFER, Meerbusch (DE); Peter SZEGENY, Engelskirchen (DE); Ömer INAN, Dorsten (DE); Andreas SCHMITZ, Velbert (DE); Andreas ZIGANKI, Mettmann (DE); Thomas LIEPOLD, Gaimerscheim (DE); Bernhard SCHWANTNER, Eichstätt (DE); Christian BARMSCHEIDT, Duisburg (DE); Michael HERRMANN, Neukirchen-Vluyn (DE); Tobias KLOCKE, Mettmann (DE); Ulrich WEICHSEL, Duisburg (DE)

(73) Assignee: Kiekert Aktiengesellschaft, Heiligenhaus (DE)

(21) Appl. No.: 18/873,513

(22) PCT Filed: May 31, 2023
(86) PCT No.: PCT/DE2023/100401

§ 371 Date: Dec. 19, 2024

(30) Foreign Application Priority Data
Jun. 14, 2022 (DE) 10 2022 114 890.4

(51) Int. Cl. E05B 81/86; E05B 85/02

(52) U.S. Cl. CPC E05B 81/86; E05B 85/02

(57) ABSTRACT

The invention relates to a motor vehicle lock (11) having a control device (1), wherein the control device (1) comprises a circuit board (2, 12) having a first plane (A-A, D-D) and electronic components (3, 20) which are arranged thereon and are connected to the circuit board (2, 12), and an energy store (4, 15, 16) which is connected to the circuit board (2, 12) and is arranged in a second plane (B-B, C-C) offset with respect to the first plane (A-A, D-D) and at least partially above the electronic components (3, 20).

The invention relates to a motor vehicle lock having an electronic control device, wherein the control device has a circuit board with electronic components connected to the circuit board and arranged thereon in a first plane, and an energy store connected to the circuit board.

Motor vehicle locks are understood to mean locks for a motor vehicle, which can be arranged in different motor vehicle parts. The motor vehicle lock or, in particular, a locking mechanism of the motor vehicle lock interacts with a locking bolt as soon as an associated motor vehicle door, motor vehicle hatchback, motor vehicle sliding door, or the like is closed. For this purpose, the motor vehicle lock is usually arranged in or on the motor vehicle door in question. In contrast, the locking bolt is located on the body—for example, on a B or C pillar. The locking bolt, which can also be referred to as lock holder, and the motor vehicle lock together define a motor vehicle door lock.

A plurality of functions are included in modern motor vehicle locks, e.g., a central locking system, a child lock, anti-theft protection, or anti-crash protection, which, on the one hand, take over safety-relevant functions or increase the comfort in the motor vehicle. In most cases, these functions are indirectly or directly powered or activated by means of an electric motor. To control these motor vehicle locks, the motor vehicle locks include electronic control devices. An electronic control device for controlling a motor vehicle lock conventionally consists of a circuit board as well as electronic components and energy stores arranged on the circuit board. The electronic control device is usually also arranged in the motor vehicle door, motor vehicle tailgate, motor vehicle sliding door, or the like. For this reason, it is necessary for the electronic control device to be dimensioned sufficiently small that it can be installed in the motor vehicle door, motor vehicle tailgate, motor vehicle sliding door, or the like in a space-saving manner.

In today's electronic control devices for controlling the movement of a side window, a motor vehicle lock, or a raising device, to name just a few uses by way of example, the required installation space results from the dimensioning of the circuit board arranged in the electronic control device, since the circuit board bears all the essential electronic components. Traditionally, the electronic components and the energy stores are arranged flatly next to each other on the circuit board in order to enable a very flat and space-saving design.

A very space-saving design is also known from EP 3 337 008 A2. The publication discloses a circuit board populated on one side and arrangeable in a control box. The narrow embodiment is achieved by the positioning of the electronic components. The energy stores are arranged flatly next to the electronic components on the circuit board. The flat design allows installation in a leaf or in a frame of the active leaf or inactive leaf.

The electronic control devices known from the prior art in a motor vehicle lock enable installation in flat doors or frames of a motor vehicle due to their flat design. However, a flat design requires a wide base area, since the electrical components are arranged next to each other and therefore require sufficient space. The base area is understood to mean the area of the electronic control device which basically results from the area of the circuit board, based upon the length and width of the circuit board. In cases in which there is not enough installation space in the motor vehicle for a flat but wide electronic control device, the electronic control devices or power supplies described in the prior art reach their limits and cannot be installed. This is where the invention starts.

The object of the invention is to provide an improved electronic control device for controlling, in particular, a motor vehicle lock. In particular, it is an object of the invention to provide an electronic control device, in particular for controlling a motor vehicle lock, which has a reduced base area and can therefore also be installed when only little installation space is available. Furthermore, it is an object of the invention to ensure safe storage of the electrical components.

The object of the invention is achieved by the features of the independent claims. Advantageous embodiments of the invention are described in the dependent claims. It should be noted that the exemplary embodiments described below are not limiting; rather, any possible variations of the features disclosed in the description, the dependent claims, and the drawings are possible.

Accordingly, the object of the invention is achieved by a motor vehicle lock having an electronic control device which is designed to control in particular a motor vehicle lock, a door opener, etc., wherein the control device has a circuit board with electronic components connected to the circuit board and arranged thereon in a first plane, and an energy store connected to the circuit board, and the energy store is arranged in a second plane, offset from the first plane, and at least partially above the electronic components.

The arrangement according to the invention of the electronic components and the energy store, also called control electronics, ensures that the base area of the electronic control device or the area of the circuit board is reduced in comparison to conventional electronic control devices, since the electronic components and the energy stores are arranged one above the other. The height of the electronic control device is only slightly increased by the proposed two-plane structure, since energy stores are usually designed to be flat and have a low height. The compact design not only enables installation in door elements with only limited available space, but also makes the electronic control device and therefore the motor vehicle lock more robust and lighter due to the reduced size.

Where the term “door element” is used in the sense of the invention, this term refers in particular to components which are movably arranged on the motor vehicle and are held in a secured position by means of a motor vehicle lock and/or can be actuated by means of an electric drive. It can be a side door, a hood, a sliding door, a hatchback, a cover, or a comparable component on the motor vehicle. By means of the electric drive, locking, unlocking, child protection, releasing, or a comparable function can be carried out in the motor vehicle lock, which function is operated by means of an electric motor and therefore requires an electrical energy supply.

Even though the invention is primarily referred to in the description with reference to a control device of a motor vehicle lock, this is not to be understood as limiting. The control device can also be used in other regions of the motor vehicle, as well as, for example, to control a charging lock.

If, in the sense of the invention, reference is made to “above” or “one above the other,” this means in particular that the two planes are not identical, do not intersect, are spaced apart from one another, are offset spatially, in particular in the direction of a plane normal, and/or are arranged almost parallel to one another. This provides a two-plane structure in which the two planes are arranged one above the other in particular in layers. In the prior art, the electronic components are usually arranged next to each other on the circuit board of an electronic control device. However, an essential point of the invention is that, in the electronic control device used according to the invention, the energy stores on the circuit board, also called a printed circuit board, are arranged at least partially above the electronic components. In the usual design, the circuit board preferably has electrical conductor tracks, wherein the electrical components such as microswitches can be coupled to one another by means of the electrical conductor tracks. The base area of the electronic control device, which basically results from the area of the circuit board, can be reduced by the two-plane structure. The arrangement of the electrical components on the circuit board is preferably one-sided. This means that only one side of the circuit board is equipped with the electronic components. The circuit board can also be equipped with electronic components or the like on both sides.

If the energy store and the electronic components are arranged at least partially congruently one above the other in the first plane and the second plane, an advantageous embodiment can again be provided. This reveals a significant advantage of the invention, viz., that the base area of the circuit board can be just large enough for the electronic components to be arranged thereon. The energy store, which would traditionally take up a relatively large amount of space on the circuit board, is arranged at least partially congruently, preferably completely congruently, in a second plane above the electronic components. The energy store of the control apparatus is preferably positioned such that it is arranged in a second plane in the z-direction above the electronic components. The z-direction is preferably the direction in which the longitudinal axis of the control apparatus is oriented. The z-direction is preferably oriented to be perpendicular to the surface normal of the circuit board. The two-plane structure allows the control apparatus to be reduced in its base area.

In principle, various energy stores can be used as energy stores in the context of the invention. However, according to a preferred embodiment variant, the energy store comprises a supercapacitor, also called an ultracapacitor or “super cap.”

When arranging the energy store above the electronic components, it is advisable to fix it in a stable manner due to the high intrinsic weight of the energy store. In addition to the energy store, a possible contact unit of the electronic control device, such as a circuit board connector, also called a circuit board plug-in connector, is one of the relatively heavy components and requires stable fixation in order to prevent these heavy components from breaking off or being damaged, especially in the event of strong accelerations or vibrations.

It can be advantageous and form an embodiment variant of the invention if the electronic control device as part of the motor vehicle lock has a housing and a housing cover arranged thereon, wherein the circuit board with the electronic components and the energy store are arranged within the housing, and the energy store is fixed in place by the housing and/or by the housing cover. The housing, or the bottom of the housing, can preferably form the first plane, and the housing cover can preferably form the second plane, so that the housing cover or the second plane is arranged above the housing bottom or above the first plane. However, it is also possible for the housing cover to be arranged above the second plane and enclose the energy store which is arranged in the second plane.

This can ensure a stable fixation of the heavy energy store.

It can also be advantageous if the housing and/or the housing cover comprises plastic and/or metal. The plastic material and/or the metal enable a variety of different stable fixing options for the energy store in the housing and/or housing cover.

It can also be advantageous and form an embodiment variant of the invention if the housing and/or the housing cover has a recess into which the energy store can be inserted and can be fixed in place by closing the housing cover. Preferably, the energy store is connected to the circuit board in a first side and fixed in place in a second side. In this embodiment variant, the fixation is preferably carried out by positioning one side of the energy store on and/or in a recess of the housing and/or the housing cover so that the energy store is fixed in a plane parallel to the circuit board in a horizontal direction. By closing the housing with the housing cover, the energy store can also be fixed in place in a vertical position.

The recess of the housing and/or the housing cover is preferably designed as a holding apparatus, which is formed, for example, by a storage contour in the housing. A projection is designed in the housing, the contour of which matches the contour of the parts to be held. The parts to be held can then be placed on the projection in a form-fitting manner. The holding apparatus can also be formed, for example, by an intermediate element with a recess. The parts to be held can then be guided into or through the recess so that they can be held by the intermediate element.

The fixation in place can be achieved, for example, by clipping the energy store into the recess and/or attaching the housing cover to the housing by clipping and/or using plug connections. The fixation can also comprise screwing or gluing.

A further embodiment of the invention is achieved when the energy store is at least partially injected into the housing. The energy store can be at least partially integrated into the housing and/or the housing cover. The integration is preferably carried out by embedding the energy store in the plastic material of the housing and/or the housing cover. This embedding can be done, for example, via a plastic injection-molding process. Alternatively, it is possible to coat the housing and/or the housing cover with an epoxy resin or soak it in an epoxy resin, and to enable the energy store to be embedded in the epoxy resin layer. Preferably, other heavy electrical components such as the contact unit of the electronic control device are embedded, since these also require particularly stable fastening due to their high weight.

In a further embodiment variant of the invention, the energy store is held at least regionally in an elastomeric bearing. In particular, elastic bearing of the heavy energy stores is advantageous in the event of vibrations that occur during operation of the vehicle. The elastic bearing in an elastomeric plastic can elastically absorb the kinetic energy of the energy store. The elastic holder of the energy stores can be regionally arranged around the circumference of the energy stores so that a form-fitting receptacle of the energy stores can ensure a secure hold. The elastomer can regionally accommodate and hold the energy store at a point or also in several regions. Preferably, cylindrical energy stores are used which are held in the elastomeric material in a form-fitting and at least partially circular manner.

If the elastomeric bearing is designed as a separate component and/or as an integral part of the housing, an advantageous embodiment variant of the invention can again be achieved. The elastomer used as a bearing, i.e., the elastic material, can be accommodated as a separate component in a form-fitting manner in the housing of the motor vehicle lock. This results in embodiment variants in which the energy stores can only be arranged regionally above the circuit board, since the elastomers in the housing form a bearing point for the energy stores. Of course, the bearing point can also be arranged within a recess in the circuit board, for example, so that an elastic bearing for the energy store can be provided. The elastomeric material can be inserted as an independent component into the housing and in particular into the dry space of the motor vehicle lock, or can form an integral part of the housing. Two-component injection-molding processes are advisable, for example, where the different materials can be manufactured in one tool and made available as a bearing point for the energy stores. Preferably, two energy stores are used, wherein a single separate component can be used, wherein the separate component can, for example, be inserted into the housing in a form-fitting manner and in turn can, for example, provide a form-fitting receptacle for the energy stores. Even though two energy stores are preferably mentioned, it is of course also possible for only one energy store or more than two energy stores to be accommodated in the motor vehicle lock. In a further embodiment variant, the energy stores can be fixed by means of the housing cover and an elastomeric bearing. The elastomeric regions can be arranged regionally on the circumference of the energy stores or energy store so that a form-fit with respect to the energy store can preferably be provided. The elastomeric regions can also be arranged to be diametrically opposed, such that, for example, the energy store can be fixed on both sides. On the one hand, it is possible to directly contact the energy stores by means of the housing cover and to hold or fix them against the elastomeric bearing and, on the other, it is also possible to provide an elastomeric bearing or receptacle for the energy stores on the housing cover so that the energy stores can be held mounted in an elastomeric material on at least two sides, for example.

The elastomeric material or the elastic bearing of the energy store(s) can consist of an elastomeric material, such that, by means of the housing, initial stress can be produced through the housing cover via the energy store(s) in the elastomeric material. The elastomeric material can also have a rib structure, for example, so that the energy store is held at several support points or accommodation lines in the elastomeric material. This allows the damping rate to be adjusted, and the weight of the elastomer damping body is simultaneously reduced to a minimum.

It can also be advantageous and form a further embodiment variant of the invention if the energy stores are connected to the circuit board by means of at least regionally elastic connections. The connection of the energy stores via spring-loaded contacts or at least regionally spring-loaded contacts makes it possible in this case to cushion any movements that arise in the heavy energy stores via the electrical connections. In other words, any movements of the energy stores that arise can be kept away from the circuit board. Movements of the energy stores are therefore not transmitted to the printed circuit or circuit board, but are absorbed by the elastic connections. This means that, on the one hand, an elastic bearing for the energy stores can be provided, and, on the other, the circuit board can be protected from stresses from the movement of the energy stores.

Furthermore, a method according to the invention for producing an electronic control device for controlling a motor vehicle lock is provided. In a first step, a circuit board is arranged with electronic components arranged thereon in a first plane and connected to the circuit board. In a second step, an energy store connected to the circuit board is arranged in a second plane, offset from the first plane, and at least partially above the electronic components. Consequently, a circuit board is produced on which the electronic components are arranged in a first plane, and the energy store is arranged in a second plane partially above the electrical components.

Advantageously, in a further step, the circuit board with the electronic components and with the energy store is inserted into a housing, wherein the housing fixes at least the energy store in place. For example, the energy store is clamped by the housing, or the energy store is clipped into the housing.

Advantageously, in a further and/or alternative step, the circuit board with the electronic components and with the energy store is overmolded with a plastic in order to obtain the housing. The energy store is preferably overmolded with a plastic in such a way that the energy store becomes an integral part of the housing and/or the housing cover and is therefore fixed in place.

In a further advantageous method step, the energy store is arranged at least regionally in an elastic bearing. Advantageously, the insertion of the energy store into the elastic bearing can protect the sensitive component from being overloaded. In addition, the elastic receptacle allows the insertion of the energy store into the elastomeric bearing to form a balance in relation to the circuit board. Advantageously, the energy stores are also connected to the circuit board by means of elastic contacts.

Further embodiments and advantages of the method similar to the control device described above will be apparent to a person skilled in the art.

The invention is explained in more detail below with reference to the accompanying drawings on the basis of a preferred exemplary embodiment. However, the principle applies that the exemplary embodiment does not limit the invention, but is merely an advantageous embodiment. The features depicted can be implemented individually or in combination with further features of the description as well as what is claimed-individually or in combination.

In the drawings:

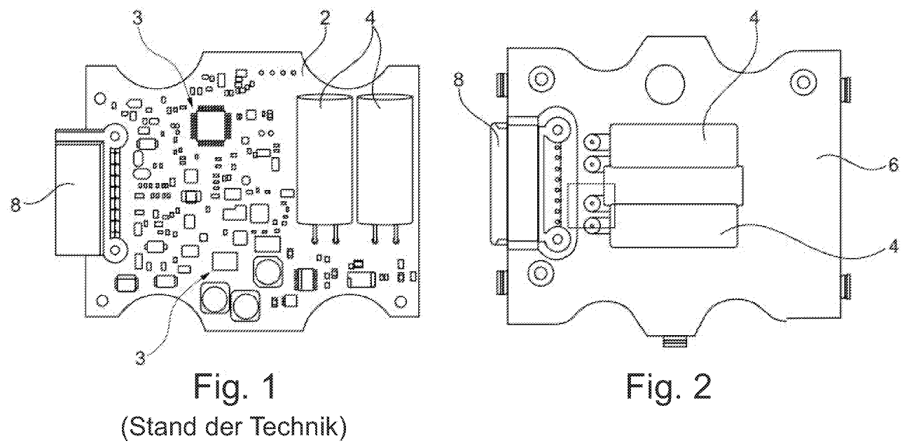

FIG. 1 shows a circuit board of a control device according to the prior art in a schematic plan view;

FIG. 2 shows a housing cover of a control device according to a preferred exemplary embodiment of the invention in a schematic plan view;

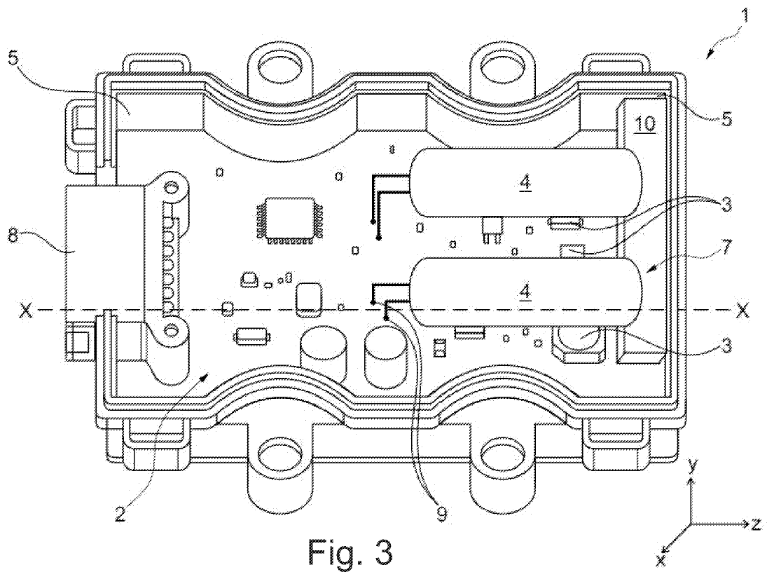

FIG. 3 shows an electronic control device according to a preferred exemplary embodiment of the invention in a schematic perspectival view;

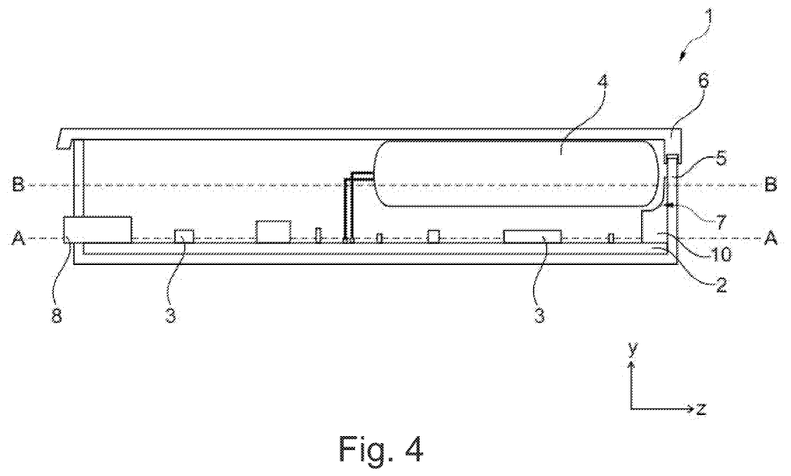

FIG. 4 shows the electronic control device according to FIG. 3 according to the preferred exemplary embodiment of the invention in a sectional view, and

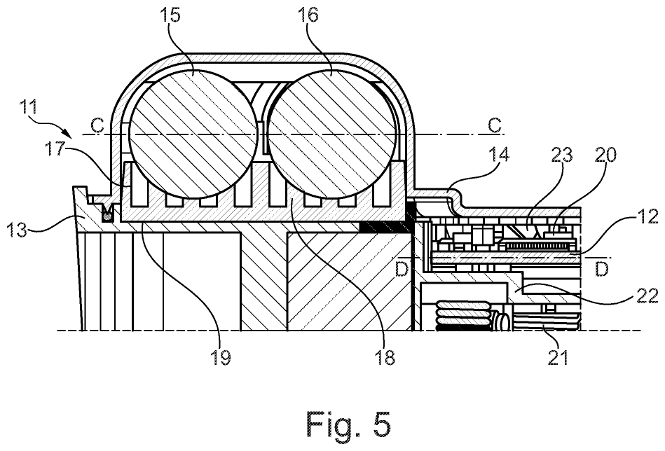

FIG. 5 shows a cross-section through a motor vehicle lock constructed according to the invention with an elastic bearing of the energy stores in a section through the circuit board and the elastically borne energy stores.

In FIG. 1, a circuit board 2 of an electronic control device according to the prior art is shown in a plan view. On the circuit board 2, electronic components 3, energy stores 4, and a contact unit 8 are arranged next to each other in one plane.

In FIG. 2, a housing cover 6 of an electronic control device 1 according to a preferred exemplary embodiment of the invention is shown in a plan view. Unlike the prior art, circuit board 2 shown in FIG. 1, the energy stores 4, and/or the contact unit 8 are now at least partially integrated into the housing cover 6. This means that the energy store 4 and/or the contact unit 8 are connected to the housing cover 6 in a form and/or force fit. Furthermore, the energy stores 4 integrated into the housing cover 6 are arranged above the electronic components 3 (not shown here) arranged on the circuit board 2, as described further below.

The energy store 4 and/or the contact unit 8 can be pushed into a recess or opening provided in the housing cover 6 and/or fixed to the housing cover 6 by means of, for example, gluing and/or screwing. Alternatively, the energy stores 4 and/or the contact unit 8 can be at least partially integrated into a plastic material of the housing cover 6 by injection. For example, in a plastic injection-molding process, the energy store 4 and/or the contact unit 8 can become integral components of the housing cover 6 molded from the plastic material.

Alternatively, the energy store 4 and/or the contact unit 8 can be integrated, not into the housing cover 6, but at least partially into a housing 5, so that the energy store 4 and/or the contact unit 8 are connected to the housing 5 in a form-fitting and/or force-fitting manner. For this purpose, for example, the energy store 4 and/or the contact unit 8 can be shoved into a recess or opening provided for this purpose in the housing 5 and/or fixed by means of, for example, gluing and/or screwing and/or by closing the housing 5 with the housing cover 6.

In FIG. 3, an electronic control device according to a preferred exemplary embodiment of the invention is shown in a perspectival view. The energy store 4 and the contact unit 8 are partially integrated into the housing 5 as described in detail below. The circuit board 2 is arranged in the housing 5 of the electronic control device 1. On the circuit board 2, both the contact unit 8 and the electronic components 3 are arranged in a first plane. The energy stores 4 are arranged in a second plane above the first plane, i.e., above the electronic components 3, and are galvanically connected to the circuit board via electronic contacts 9. As in other conventional circuit boards, electrical conductor tracks for contacting the electronic components 3 and the energy store 4, which are not shown here, are embedded in the circuit board 2.

The energy stores 4 are aligned with their longitudinal axis along the z-direction shown in FIG. 3. Because the energy stores 4 are arranged above the electronic components 3, the base area is reduced compared to designs known from the prior art. Recesses 7 in the housing 5 represent an integrated holding apparatus 10. An energy store 4 is inserted by its end in a form-fitting manner into the recesses 7. For this purpose, the recess 7 is shaped according to the contour of the energy store 4. The energy stores 4 are therefore connected at one end to the circuit board 2 via the electronic contacts 9 and fixed at the other end via the recesses 7 in the housing 5.

The base area of the electronic control device 1 essentially results from the area of the circuit board 2, which is defined in FIG. 3 by the length of the circuit board 2 in the z-direction and the width of the circuit board 2 in the x-direction. Because the energy stores 4 are not arranged next to the electronic components 3 as in conventional electronic control devices for motor vehicle locks, as shown in FIG. 1, but, rather, above them, the area of the circuit board 2 or the base area of the electronic control device 1 is significantly reduced.

Since the energy stores 4 are arranged above the electronic components 3, the electronic control device 1 has a slightly greater height than conventional electronic control devices for motor vehicle locks. The height of the electronic control device 1 extends in the y-direction in FIG. 3. However, since energy stores 4 are usually designed to be relatively flat, the increase in height is small. Due to the reduced base area, material can also be saved, so that the electronic control device 1 can be manufactured more economically.

The two-plane structure is illustrated in FIG. 4. FIG. 4 shows the electronic control device 1 from FIG. 3 in a sectional view along the section axis X-X shown in FIG. 3. The electronic components 3 are arranged on the circuit board 2 in a first plane A. One of the energy stores 4 is arranged in a second plane B above the electronic components 3. The planes A and B are each spanned by a vector in the z-direction and a vector in the x-direction. The x-direction is not shown in FIG. 4 due to the two-dimensional representation. However, it is clear that plane B is located above plane A. Consequently, it is made clear that the energy store 4 is arranged above the electronic components 3.

The housing 5 encloses the recess 7 and therefore forms the integrated holding apparatus 10. The energy store 4 is inserted into the recess 7. Together with the housing cover 6, the energy store 4 is fixed in place by clamping the energy store between the recess 7 and the housing cover 6. The two-plane structure according to the invention of the electronic control device 1 for controlling a motor vehicle lock enables a compact design in that the base area of the electronic control device 1 is reduced by arranging the energy store 4 above the electronic components 3.

It is advantageous to fix in place the energy store 4 and/or the contact unit 8 by clamping, injecting, gluing, screwing, clipping in, or coating or soaking with, for example, epoxy resin so that the energy store 4 and/or the contact unit 8, which can each have a relatively high weight, are securely fixed and cannot break off or otherwise be damaged, even in the event of high accelerations and/or vibrations.

FIG. 5 depicts a section through a motor vehicle lock 11 constructed according to the invention in a cross-section through a circuit board 12, the housing 13, the housing cover 14, as well as the energy stores 15, 16. In this exemplary embodiment, the energy stores 15, 16 are arranged in a second plane C-C, and the circuit board 12 in a first plane D-D. The energy stores 15, 16 are accommodated in a form-fit in an elastomeric bearing 17, wherein the elastomeric bearing in this exemplary embodiment is rib-shaped. By means of the ribs 18, a linear contact between the elastomeric material 17 and the energy stores 15, 16 can be realized. For safely bearing or fixing the energy stores 15, 16, the energy stores are fixed between the housing cover 14 and the elastomeric material 17. In this exemplary embodiment, the elastic bearing 17 is also accommodated in a form-fitting manner in a recess 19 of the housing 13. The exemplary embodiment therefore shows the elastic bearing 1 as a separate component. Fixation of the energy stores 15, 16 is achieved in this case by pressing the housing cover 14 against the energy stores 15, 16, and consequently a contact force of the energy stores 15, 16 against the elastic bearing 17. As can be clearly seen, the planes C-C and D-D are spaced apart from each other, wherein the energy stores are arranged only regionally above the circuit board 12. The electrical contacting of the energy stores 15, 16 as well as the part of the circuit board 12 is not shown in this exemplary embodiment. The electrical components 20 on the circuit board 12 can be seen, wherein the circuit board 12 also extends below the energy stores 15, 16. In this exemplary embodiment, the energy stores 15, 16 are arranged only regionally above the circuit board 12.

Also visible in FIG. 5 is a part of the mechanism 21 of the motor vehicle lock 11, wherein the mechanism 21 is arranged separated from the dry space 23 of the circuit board 12 by means of a partition wall 22. Energy stores 15, 16, the electrical components 20, and the circuit board 12 are located in the dry space of the motor vehicle lock 11, i.e., the mechanism 21 is arranged so as to be sealed in relation to the electrical components 20, 15, 16 and the elastic bearing 17 in the motor vehicle lock 11.

### LIST OF REFERENCE SIGNS

1 Electronic control device
2, 12 Circuit board
3, 20 Electronic components
4, 5, 16 Energy stores
5, 13 Housing
6, 14 Housing cover
7, 19 Recess
8 Contact unit
9 Electronic contacts
10 Holding apparatus
11 Motor vehicle lock
17 Elastic bearing
18 Rib
21 Mechanism
22 Partition wall
23 Dry space
A-A, D-D First plane
B-B, C-C Second plane
X-X Section axis

1. A motor vehicle lock comprising:
an electronic control device, wherein the electronic control device has a circuit board with electronic components connected to the circuit board and arranged on the circuit board in a first plane, and an energy store connected to the circuit board, and
the energy store is arranged in a second plane, offset from the first plane, and at least partially above the electronic components.

2. The motor vehicle lock according to claim 1, wherein the energy store and the electronic components are arranged at least partially congruently one above the other in the first plane and the second plane.

3. The motor vehicle lock according to claim 1, wherein the energy store comprises at least one supercapacitor.

4. The motor vehicle lock according to claim 1, further comprising a housing and a housing cover arranged on the housing, wherein the circuit board with the electronic components and the energy store are arranged within the housing, and the energy store is fixed in place by the housing and/or by the housing cover.

5. The motor vehicle lock according to claim 4, wherein
the housing and/or the housing cover comprises plastic and/or metal.

6. The motor vehicle lock according to claim 4, wherein the housing and/or the housing cover has a recess into which the energy store is inserted and the energy store is fixed in place by closing the housing cover.

7. The motor vehicle lock according to claim 5, wherein the energy store is at least partially injected into the housing by embedding the energy store at least partially within plastic material of the housing.

8. The motor vehicle lock according to claim 6, further comprising an elastic bearing, wherein the energy store is held at least regionally in the elastic bearing.

9. The motor vehicle lock according to claim 8, wherein the elastic bearing is designed as a separate component from the housing.

10. The motor vehicle lock according to claim 8, wherein the energy store is fixed by the housing cover and the elastic bearing.

11. The motor vehicle lock according to claim 9, wherein the energy store is connected to the circuit board by at least regionally elastic connections.

12. A method for producing an electronic control device for controlling a motor vehicle lock, comprising the steps of:
arranging a circuit board with electronic components arranged on the circuit board in a first plane and connected to the circuit board, and
arranging an energy store, connected to the circuit board in a second plane, offset from the first plane, and at least partially above the electronic components.

13. The method according to claim 12, further comprising the step of:
inserting the circuit board with the electronic components and the energy store into a housing, wherein the housing fixes at least the energy store in place.

14. The method according to claim 13, further comprising the step of:
overmolding the circuit board with the electronic components and the energy store with a plastic to form the housing.

15. The method according to claim 12, further comprising the step of:
arranging an elastic bearing located at least regionally around the energy store.

16. The motor vehicle lock according to claim 8, wherein the elastic bearing is designed as an integral part of the housing.

17. The motor vehicle lock according to claim 1, wherein the first plane and the second plane are parallel to each other.

18. The motor vehicle lock according to claim 4, wherein the housing forms the first plane and the housing cover forms the second plane.

19. The motor vehicle lock according to claim 8, wherein the elastic bearing has a rib structure to hold the energy store at multiple support points.
